(19) United States
(12) Patent Application Publication
(10) Pub. No.: US 2020/0223725 A1
(43) Pub. Date: Jul. 16, 2020

(54) Method of Continuous Temperature Stabilization and Effluent Cooling Using Bioremediation Elements inside Grease Interceptors, FOG's, Vaults and other Waste Collection Enclosures

(71) Applicant: Markus Johannes Lenger, Capistrano Beach, CA (US)

(72) Inventor: Markus Johannes Lenger, Capistrano Beach, CA (US)

(21) Appl. No.: 16/245,151

(22) Filed: Jan. 10, 2019

(51) Int. Cl. C02F 3/12; C02F 3/10; C02F 3/22; C02F 1/40

(52) U.S. Cl. CPC C02F 3/1294; C02F 3/109; C02F 2101/32; C02F 1/40; C02F 3/223

(57) ABSTRACT

A method to continuously stabilize and cool effluent temperatures in FOG (Fats, Oils and Greases) discharged into Grease Traps (GT) or Grease Interceptors (GI). Temperature stabilization/cooling became necessary with the introduction of water efficient dish washing systems that produce discharge water too high in temperature to maintain a functioning grease interceptor/trap. This temperature stabilization/cooling is achieved with Bio-Elements located inside the grease interceptor or grease trap, therefore representing an in-situ process.

Temperature stabilization/cooling is achieved by continuously measuring the effluents' temperature inside the FOG enclosure and by controlling air pumps to achieve the necessary cooling to restore the GT/GI designed function. Said air supplies the needed oxygen to maintain an aerobic biofilm suitable for bioremediation, maintain flow through the Bio-Elements, and also to cool the effluent, which is typically too high in temperature to enable effective bioremediation or function of a grease interceptor.

### FEDERALLY SPONSORED RESEARCH

Not Applicable

### SEQUENCE LISTING OR PROGRAM

Not Applicable

### BACKGROUND

### Field of Invention

This invention relates to wastewater and solid treatment, specifically the control and optimization of bioremediation of Grease and Bio solids in Grease Interceptors, Vaults and other Waste collection enclosures.

Applicant has invented a novel method to continuously stabilize and cool effluent temperatures in effluent, commonly referred to as FOG (Fats, Oils and Greases) discharged into grease interceptors or grease traps. This temperature stabilization/cooling is achieved with Bio-Elements located inside the grease interceptor or grease trap, therefore representing an in-situ process. This method is an improvement on applicants' earlier invention titled “Device for In Situ Bioremediation of Liquid Waste”-U.S. Pat. No. 7,615,156 B2 issued Nov. 10, 2009. Temperature stabilization/cooling is achieved by continuously measuring the effluents' temperature inside the FOG enclosure, ideally near the biofilm that is maintained inside the Bio-Elements. The air pump used to maintain flow through the Bio-Element also supplies the needed oxygen to maintain an aerobic biofilm suitable for bioremediation. Applicant has now added the additional (and third) function for the injected air (the first 2 functions are 1. recirculation of effluent and 2. supplying sufficient oxygen to maintain an aerobic bioremediation process as described in applicants' earlier invention titled “Device for In Situ Bioremediation of Liquid Waste”-U.S. Pat. No. 7,615,156 B2 issued Nov. 10, 2009) to cool the effluent with additional and/or more powerful pumps achieving increased air flow allowing for effective cooling to maintain desired temperature. This ensures proper functioning of any grease interceptor or grease trap by cooling the effluent, which is typically too high in temperature to enable effective bioremediation (as described in Applicants' patent U.S. Pat. No. 7,615,156 B2).

### BACKGROUND

### Prior Art

Beginning in 2014, a new generation of ultra-energy-efficient and water-efficient commercial dishwashers have been introduced into the market and continue to replace older less efficient dishwashers. While such dishwashers use considerably less water, they require more heat to achieve the same cleaning action and to ensure appropriate sterilization. Recent foodborne illnesses have increased and a need for increased sterilization in the form of higher temperatures is thought to be the solution. The FDA (Food and Drug Administration) requires a minimum water temperature of 85° C. (185° F.) for all commercial food service dishwashers. The wash water acts as a heat sink to evacuate the excess thermal energy resulting in the effluent having much higher temperature than previously seen—commonly between 63° C. (145° F.) and 74° C. (165° F.).

High effluent temperatures from Food Service Establishments (FSE's) is an area of emerging concern and were first brought to the attention of IAPMO (International Association of Plumbing and Mechanical Officials), the authoring body of the UPC (Uniform Plumbing Code) at their meeting on Apr. 4, 2016 in Ontario, CA by the applicant himself Subsequently, a task force is being formed to address this concern and to write relevant codes and standards to address the problem. As such, no technological applications other than the applicants are known to this date.

Such discharge temperatures are not only problematic for the plumbing system, as common plumbing components made from ABS and PVC are neither rated nor do they maintain their structural integrity, but also severely impede the capability of grease interceptors and grease traps to function. Such systems typically require an effluent temperature of 24° C. (75° F.) or less to effectively separate and sequester the FOG's. Applicant has measured average effluent temperatures inside such interceptors to be 37° C. (98° F.), well above the temperature that allows FOG's to be separated. Simply put, at a discharge temperature above 24° C. (75° F.) the FOG's are still dissolved in the effluent and almost completely bypass these grease control devices. The result is failure to comply with local, state and federal discharge requirements. Fines, closures and subsequent legal actions are a common consequence.

A simple air cooling of the grease interceptors or traps is not possible due to code requirements. Construction and performance of Grease Interceptors (GI) and Grease Traps (GT) is regulated by ASME and ANSI Standards A112 14.6 2010 and Z1001. It is a requirement of the A112 14.6 Standard to not introduce any device into a GI or GT that alters the “flow and separation characteristics” of the GI/GT. This requires any treatment of the contained FOG to not alter the critical base functions of a GI/GT. A simple injection of cooling air would therefore violate these performance standards, as these methods would introduce turbulence and therefore negatively interfere with the function of these grease control devices.

### SUMMARY

Only applicants' earlier invention titled “Device for In Situ Bioremediation of Liquid Waste”-U.S. Pat. No. 7,615,156 B2 issued Nov. 10, 2009 can deliver air inside a grease interceptor or grease trap without violating current ASME/ANSI standards and a grease interceptors' certified function.

Furthermore, effluent cooling is also desirable because the effectiveness of bioremediation is highly dependent on temperature. At 37° C. (98° F.) the microbes are still alive (they start dying at around 55° C. (130° F.)) but are in respiratory distress due to the lack of dissolved oxygen the water can hold at this temperature, thus their effectiveness is considerably compromised. Cooling is also needed to achieve effective bioremediation of FOG as described in applicants' earlier invention titled “Device for In Situ Bioremediation of Liquid Waste”-U.S. Pat. No. 7,615,156 B2 issued Nov. 10, 2009. Therefore, this novel approach of cooling enables the bioremediation process to be more effective and maintains the initial function of the grease interceptor/trap.

### DETAILED DESCRIPTION FIG. 1

### Illustrated Embodiment

To continuously maintain a desirable temperature range either additional air pumps or larger air pumps must be employed. As temperature variation and wide ranges are common in the discharge of FSE's an adaptive control system is paramount. The temperature of the effluent in each interceptor chamber must be measured via a temperature sensor ideally mounted on or inside the Bio-Elements near the biofilm to ensure optimal temperature for the bioremediation process. Additionally, a temperature sensor inside the chamber (but outside the Bio-element) maybe used to measure the delta temperature between the cooled effluent inside the Bio-Element and the ambient temperature of the effluent outside the Bio-Element. Either direct or contactless temperature readings maybe employed.

A PAC (Phase Angle Controller) or VFD (Variable Frequency Drive) controller can be used to throttle the air pump(s) to maintain the desired air flow to achieve a set temperature (typically between 24° C. (75° F.) and 32° C. (90° F.), but any method to control the air pumps sufficiently may be employed, such as other electrical or mechanical means. A temperature controller, a PLC (Programmable Logic Controller) or a similar device can be used to measure the current temperature and ramp the air pump up and down accordingly to achieve the desired set temperature. Alternatively, the pump can be cycled on until the target temperature is reached and then turned off until further cooling is needed again. This reduces cost as the PAC/VFD can be replaced with an inexpensive relay.

Additional cooling of the injected air may be applied to reach the desired temperatures and increase cooling efficiency, for example in hot climates.

However, due to the above-mentioned ANSI requirements, the aeration method and technology must be capable of delivering enough air for cooling while not interfering with the inherent functions of a GI/GT. One such method is one of the applicants' earlier inventions U.S. Pat. No. 7,615,156 “device for in-situ bioremediation of liquid waste”. This technology has also been certified against the above-mentioned ASME A112 14.6 Standard. To assist in explaining our methodology, applicant will refer to above mentioned patented device as means for aeration and biological treatment. However, this should not be construed as a limitation as any aeration device suitable, whilst still fulfilling the Standards' requirement, can be used.

The following steps detail the method:
1. Closed Loop Aeration. A method of aerating the contents of a GI/GT sufficiently to maintain a dissolved oxygen level of 0.5 mg/l or higher. Said method may not interfere with the separation characteristics of a GI/GT, such as interference in layer separation, interference in gravity separation, bypassing grease or solids, emulsifying grease or promoting a channeling effect. Applicant is currently only aware of one method to achieve this and that is Lenger et al U.S. Pat. No. 7,615,156.
2. Continuous Liquid Recirculation. The closed loop aeration mentioned above also supplies a continuous recirculation of the effluent through the Bio-Elements and therefore throughout the entire grease interceptor/grease chamber as described in Lenger et al U.S. Pat. No. 7,615,156. As a grease interceptor/trap typically has at least two chambers, one Bio-Element per chamber is required. Depending on the size of the chamber and the effluent temperature more than one Bio-Element per chamber may be required.
3. Increased Air Flow. The airflow typically used in Lenger et al U.S. Pat. No. 7,615,156 is 80 LPM (Liters Per Minute) or 2.83 CFM (Cubic Feet per Minute) per Bio-Element to maintain continuous recirculation and a dissolved oxygen level of 0.5 mg/l or higher and is not sufficient to achieve the desired thermal transfer/cooling. Therefore, the air volume must be increased considerably. Practical applications have shown that 200 LPM (7 CFM) per Bio-Element appears sufficient if the inflow temperature is between 35 and 38° C. (95-100° F.) in a 4,730 liter (1,250 gallon) grease interceptor. Depending on the size of the chamber and the influent temperature more than one Bio-Element per chamber may be required. As a consequence, the air volume must be increased accordingly.
4. Temperature Stabilization. To optimize the cooling process as well as keeping turbulence formation to an absolute minimum, only as much air as needed should be injected into the Bio-Elements. This also optimizes the energy usage. The temperature sensor(s) should be ideally mounted on or inside the Bio-Elements and near the biofilm to ensure optimal temperature for the bioremediation process. Additionally, a temperature sensor inside the grease interceptor chamber is used to measure the delta temperature between the biofilm and the ambient water temperature to further optimize the temperature stabilization. Since it is mandated by plumbing code that all grease interceptors are vented, passive or active means to evacuate the hot air from the grease interceptors can be deployed using these existing mandated vents. To achieve effective temperature reduction an ambient air temperature sensor may be installed. Since temperature drops from chamber to chamber, each interceptor chamber needs a separate temperature sensor and independent temperature control. Contactless infrared temperature sensors can be used to measure the water temperature surrounding the Bio-Elements as well as ambient air temperature inside the grease interceptor chamber. A temperature controller, a computerized control system, a PLC (Programmable Logic Controller) or a similar device can be used to measure the current temperature and ramp the air pump up and down accordingly to achieve the desired temperature setting.
5. Biological Treatment. Applicants' prior invention U.S. Pat. No. 7,615,156 also allows the injection, growth and continuing function of a biofilm within the device.

Restoration of inherent Grease Interceptor/Trap Function. As mentioned above, there is a proliferation of new energy and water efficient dish washing systems producing high water temperatures unsuitable for most plumbing systems. The extreme high temperatures also cause the operational failure of grease interceptors and grease traps resulting in the FOG's inability to fall out of solution within the GI/GT. FOG therefore, bypasses the very system that was designed to trap it. Applicants' novel effluent cooling and temperature stabilization system restores the intended function of grease interceptors and grease traps by cooling the contents to a temperature where it allows the FOG content to fall out of suspension and be trapped, even if the bioremediation function has been damaged or is not functioning, either by operator input or failure of the microbial injection system as described in U.S. Pat. No. 7,615,156.

### DETAILED DESCRIPTION

### FIGS. 1 and 2

### Illustrated Embodiment

### Drawing

Applicant has included one drawing sheet explaining the improved Bio-Element function and cooling set up.

FIG. 1: An elevated front perspective cut away view of the devices installed in a typical layout for a grease interceptor including all components needed for effective effluent cooling.

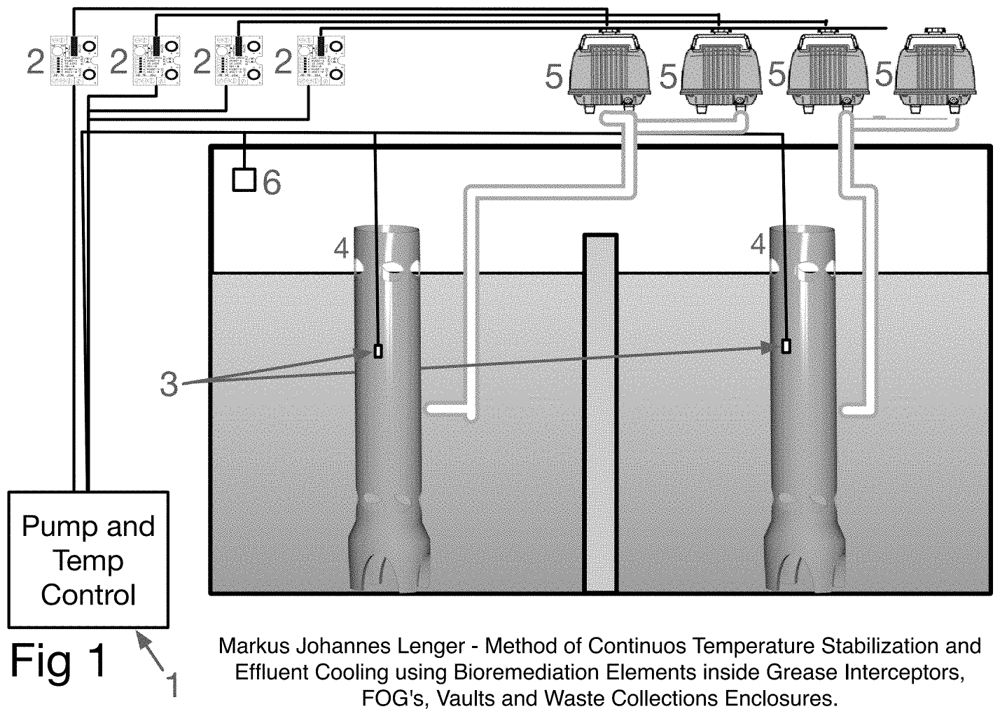

### DRAWING AGENDA

1 Temperature Controller, PLC or similar device
2 Pump Controller such as PAC, VFD or relay
3 Temperature Sensor
4 Bio-Elements as in U.S. Pat. No. 7,615,156
5 Air Pump(s)
6 Water or Ambient Air contactless infrared temperature sensor

### CONCLUSIONS, RAMIFICATIONS, AND SCOPE

As FSE discharge temperatures are now officially an area of growing concern, an effective way of cooling this effluent is needed without compromising the established protocols in dealing with FOG waste. Particularly, the formation of turbulence is not allowed, drastically limiting ways of cooling the effluent in situ. Applicants' novel approach solves the issue elegantly as it operates within all applicable codes especially the ASME 112 14.6 Standard governing internal grease disposal systems.

Applicants' novel cooling system is being installed at a site at the Miami International Airport and has therefore achieved commercial success.

Applicant believes this invention is an important, novel, un-obvious and significant expansion of the capabilities of the original Bio-Element as described in the previous invention titled “Device for In Situ Bioremediation of Liquid Waste”-U.S. Pat. No. 7,615,156 B2 issued Nov. 10, 2009. Given the severe impact of non-functioning GI/GT's and its impact on both the plumbing and sewer system, applicant believes the improvements are significant, important and timely.

1-9. (canceled)

10. A method of treating wastewater in a chamber, waste enclosure or vault comprising of:
(a) feeding wastewater into said chamber,
(b) providing an elongated substantially vertical enclosure having a base with at least one inflow opening resting on the bottom of said chamber and an upper substantially solid-walled portion terminating at an upper opening at or below a liquid level within said chamber,
(C) providing a plurality of substantially vertical arranged bio media supporting a microbial film within said upper portion of said enclosure,
(d) aerating said wastewater by generating a Venturi effect through and around said bio media by an aerator located between said inflow opening and a bottom of said bio media,
(e) said air from aerator providing means of heat exchange within said wastewater,
(f) removing treated wastewater from said chamber.

11. The method of claim 1, wherein said wastewater contains Fats, Oils and/or Grease (FOG).

12. The method of claim 1, wherein said wastewater exceeds a temperature of 24° C. (75° F.).

13. The method of claim 1, wherein a temperature sensor is positioned to communicate the temperature of said wastewater in the close proximity of said biofilm to a pump and temperature controller.

14. The method of claim 1, wherein said air from aerator providing means of heat exchange is controlled by a pump and temperature controller.

15. The method of claim 4, wherein said pump and temperature controls volume of said aeration.

16. The method of claim 1, wherein said air from aerator providing means of heat exchange may be previously cooled by external means.

17. The method of claim 1, wherein said aeration provides the oxygen to maintain aerobic bioremediation.

18. The method of claim 1, wherein said aeration generates sufficient lift to maintain liquid circulation throughout said vertical enclosure and chamber simultaneously.

19. The method of claim 1, wherein said aeration generates sufficient heat exchange to act as a heat sink.

20. The method of claim 1, wherein said aeration generates sufficient cooling to reduce said wastewater temperature to a level sufficient to maintain aerobic bioremediation, typically between 24° C. (75 F) and 40° C. (104° F.).

21. The method of claim 1, wherein said aeration generates sufficient cooling to reduce said wastewater temperature to a level capable of maintaining gravity-based FOG and water separation, typically between 24° C. (75° F.) and 40° C. (104° F.).

22. The method of claim 1, wherein said aeration generates sufficient cooling/heat exchange to reduce said wastewater temperature to a level capable of maintaining air entrapment-based FOG and water separation, typically between 24° C. (75° F.) and 40° C. (104° F.).
